(19) United States
(12) Patent Application Publication
(10) Pub. No.: US 2023/0025169 A1
(43) Pub. Date: Jan. 26, 2023

(54) CONTRASTIVE REPRESENTATION LEARNING FOR MEASUREMENT DATA

(71) Applicant: Robert Bosch GmbH, Stuttgart (DE)

(72) Inventors: David Hoffmann, Pforzheim Hohenwart (DE); Mehdi Noroozi, Stuttgart (DE); Nadine Behrmann, Stuttgart (DE)

(21) Appl. No.: 17/812,211

(22) Filed: Jul. 13, 2022

(30) Foreign Application Priority Data
Jul. 26, 2021 (EP) 21 18 7773.3

(51) Int. Cl. G06N 20/00

(52) U.S. Cl. CPC G06N 20/00

(57) ABSTRACT

A method for training an encoder that maps data samples of measurement data onto machine-evaluable representations. In the method, a set of training samples is provided, a relation being defined, in the context of a specified application, concerning the degree to which two samples are similar to one another. A function is provided that is parameterized with trainable parameters and that maps samples onto representations. A similarity measure is provided that assigns samples a similarity of representations and/or of processing products of these representations. From the set of training samples, at least one query sample is drawn. For this query sample, the following are ascertained: a set, ordered in a ranked order, of positive samples from the set that are similar to the query sample, and a set of negative samples from the set that are no longer similar to the query sample. At least the parameters are optimized.

### CROSS REFERENCE

The present application claims the benefit under 35 U.S.C. § 119 of European Patent Application No. EP 21 18 7773.3 filed on Jul. 26, 2021, which is expressly incorporated herein by reference in its entirety.

### FIELD

The present invention relates to the training of encoders that map data samples of measurement data onto representations that can be evaluated by machine, the representations being usable for a multiplicity of later tasks.

### BACKGROUND INFORMATION

For the evaluation of measurement data, such as image data, in particular in the area of at least partly automated driving, machine learning methods are used. For example, an image classifier that has been trained on a set of training images having adequate variability can also correctly sort images previously completely unknown to it into classes of a specified classification. In this way, this imitates the training of a human driving student, which typically includes less than 100 hours and less than 1000 km of driving practice, but nonetheless makes the driving student capable of mastering completely new situations not addressed during the driver training. For example, drivers trained during the summer are also able to drive on snow in the winter.

In many cases, the measurement data are first mapped onto a generic machine-evaluable representation, before this representation is then evaluated with respect to the particular task. A method for producing such representations is described, for example, in European Patent No. EP 3 575 986 A1.

The goal of Deep Metric Learning (DML) is to learn embeddings that can acquire semantic items of similarity information between data points. Existing pairwise or threefold loss functions that are used in DML suffer from slow convergence due to a large proportion of trivial pairs or triplets when the model improves.

In order to ameliorate this, structured loss functions are provided that incorporate a plurality of examples and exploit the structured information between them. Wang Xinshao et al., “Ranked List Loss for Deep Metric Learning,” 2019 IEEE/CVF Conference on Computer Vision and Pattern Recognition (CVPR) (IEEE), describes, for DML, ranked-list-motivated structured losses, as well as a loss in the form of a ranked list.

### SUMMARY

In accordance with the present invention, a method is provided for training an encoder that maps data samples x of measurement data onto representations z that can be evaluated by machine.

These measurement data can include in particular for example images, audio sequences, and/or video sequences. Here, the images can have been recorded using any imaging modalities and contrast mechanisms. In addition to images recorded with visible light, for example thermal images, ultrasound images, radar images, or lidar images may also be used.

In accordance with an example embodiment of the present invention, in the method, a set X of training samples x is provided; in the context of a specified application a relation is defined concerning the degree to which two samples x₁ and x₂ are similar to one another. For example, images can contain different objects between which there is in turn a semantic relation indicating which objects are similar to one another and to what degree.

In accordance with an example embodiment of the present invention, a function ƒ_{θ} (x), parameterized with trainable parameters θ, is provided that maps samples x onto representations z. This function ƒ_{θ} (x) is intended to be made capable, through training, of producing representations z of any samples x in later effective operation. Here, a similarity relation between samples x₁ and x₂ is to be retained, in such a way that samples x₁ and x₂ that are similar to one another are mapped onto representations z₁ and z₂ that are situated close to one another in the space of the representations. In contrast, samples x₁ and x₂ that are not similar to one another are to be mapped onto representations z₁ and z₂ that are further apart from one another in the space of the representations.

In accordance with an example embodiment of the present invention, a similarity measure h(x₁, x₂) is provided that assigns to samples x₁ and x₂ a similarity of representations ƒ_{θ} (x₁) and ƒ_{θ} (x₂), and/or of processing products of these representations ƒ_{θ} (x₁) and ƒ_{θ} (x₂). That is, samples x₁ and x₂ are mapped by h(x₁, x₂) onto a numerical value that is a measure of the similarity.

In accordance with an example embodiment of the present invention, from the set X of the training samples x, at least one query sample q is now drawn. For this query sample q, the following are ascertained:
a set P, ordered in a ranked order, of positive samples p from the set X that are similar to the query sample q, and
a set N of negative samples n from the set X that are no longer similar to the query sample q.

These positive samples p and negative samples n may be taken from any source. For example, samples x can be taken randomly from the set X and subsequently divided into positive samples p and negative samples n. Alternatively, or also in combination with this, a new positive sample p′ can for example be produced from the query sample q and/or from an already existing positive sample p through the application of at least one processing step that does not modify the semantic content of this sample.

For example, excerpts can be selected from the images and can subsequently be enlarged back to the original image size. Images can also be for example mirrored about an axis. The brightness, the contrast, and the saturation of images can be adapted on the basis of parameters taken from a random distribution. Images can for example also be converted from color into grayscale with a specified probability. All of these modifications do not change anything in the semantic content of the image.

At least the parameters θ are optimized with the goal that the similarity measures h(q, p) are ordered corresponding to the ranked order of the positive samples p ∈ P, and are greater than h(q, n) for all n ∈ N.

It has been recognized that the taking into account of a ranked order among positive samples p enables a substantially more fine-grained taking into account of previous knowledge about the training samples x. In this way, a larger proportion of such previous knowledge can be profitably exploited.

As an example, consider a set X of training samples x showing various objects. If query sample q shows a dog, then, as further samples, a shark, a grasshopper, and a school bus are clearly not similar thereto, so that these are negative samples n. If a further sample then shows a dog of the same breed as in query sample q, then these two dogs are very similar, so that this sample is a positive sample p. Samples with dogs of different breeds are still similar to the query sample q, because they also show dogs, but this similarity is less pronounced than in the case of a sample with a dog of the same breed as in query sample q. Precisely this distinction can be taken into account with the method.

In conventional contrastive learning, the only categories were “positive samples p” and “negative samples n.” With regard to the stated finer-grained previous knowledge about the training samples x, this is comparable to the idea of an official form that, in one aspect, permits only the checking of one of a few alternatives, none of which however really fits the specific situation.

In a particularly advantageous embodiment of the present invention, as an aid for the evaluation of representations z, in addition a function g_{λ} (z), parameterized with trainable parameters A, is provided that transfers representations z into a working space. In such a working space, the similarity of representations can be more easily measurable than directly in the space of the representations z. Depictions g_{λ} (ƒ_{θ} (x₁)) and g_{λ} (ƒ_{θ} (x₂)) are then formed in the working space as processing products of the representations ƒ_{θ} (x₁) and ƒ_{θ} (x₂). The similarity of these depictions g_{λ} (ƒ_{θ} (x₁)) and g_{λ} (ƒ_{θ} (x₂)) [ . . . ] evaluated using the similarity measure h(x₁, x₂). Furthermore, in addition to the parameters θ the parameters λ are also optimized. The function g_{λ} (z) is thus also trained during the training of ƒ_{θ} (x), but after the conclusion of the training is not part of the final encoder for the production of representations z from arbitrary samples x.

In a particularly advantageous embodiment of the present invention, the set P of positive samples p includes subsets P₁, Pᵣ of positive samples p₁, . . . , pᵣ for rank levels 1, . . . , r in the ranked order. These subsets P₁, . . . , Pᵣ can then be handled separately from one another in checking the question to what extent concrete values for the parameters θ and λ are good or bad (for example in the context of a cost function).

In particular, for example a cost function L can be set up that is a function of the parameters θ and possibly also λ, via the similarity measures h(q, p) and h(q, n), and that is a sum of the contributions Lᵢ for the rank levels 1, . . . , r in the ranked order.

The parameters θ and possibly also λ can then be optimized with the goal of minimizing this cost function L. In this way, the optimization goal, originally formulated as the inequality

h(q,p₁)> . . . >h(q,pᵣ)>h(q,n),

can be converted into an optimization task in which a feedback can be carried out in the standard manner, via the back-propagation of gradients, for an updating of the parameters θ and λ.

In particular, for example for each rank level i=1, . . . , r an InfoNCE cost function can be evaluated as contribution Lᵢ to the cost function L. Here, InfoNCE means in particular a distinction between information and noise via a contrastive estimation (“information-noise contrastive estimation”). In this InfoNCE cost function:
the positive samples pᵢ ∈ Pᵢ of the respective rank level i are evaluated as positive samples,
the positive samples pᵢ ∈ Pᵢ remain not taken into account for rank levels j<i, and
the positive samples pᵢ ∈ Pᵢ are evaluated as negative samples for rank levels j>i.

An example of such an InfoNCE cost function Lᵢ is

$${L}_{i , i n} = - log \frac{{Σ}_{p ∈ {P}_{i}} exp ( h ( q , p ) / {τ}_{i} )}{{Σ}_{p ∈ {⋃}_{j \geq i} {P}_{j}} exp ( h ( q , p ) / {τ}_{i} ) + {Σ}_{n ∈ N} exp ( h ( q , n ) / {τ}_{i} )} ,$$

where τᵢ is a temperature parameter.

In general, the InfoNCE cost function can contain, for at least one rank level i, a logarithm of a sum of contributions that originate from the positive samples pᵢ ∈ Pᵢ of this rank level i.

This is the case in the above expression in the numerator.

However, the InfoNCE cost function can also contain, for example for at least one rank level i, a sum of contributions that originate from the positive samples pᵢ ∈ Pᵢ of this rank level i.

This is for example the case if, in the above expression, the sum over pᵢ ∈ Pᵢ is drawn from the logarithm:

$${L}_{i , out} = - {\sum }_{p ∈ {P}_{i}} log \frac{exp ( h ( q , p ) / {τ}_{i} )}{{Σ}_{p ∈ {⋃}_{j \geq i} {P}_{j}} exp ( h ( q , p ) / {τ}_{i} ) + {Σ}_{n ∈ N} exp ( h ( q , n ) / {τ}_{i} )} .$$

The difference between these exemplary cost functions L_{i,in} and L_{i,out} is that L_{i,in} is more resistant to noise in the positive samples pᵢ. For positive samples pᵢ of the first rank level, this noise can be predicted to be lower than for positive samples pᵢ of further rank levels i=2, . . . , r. Therefore, the overall cost function L can also contain for example a mixture of cost functions L_{i,in} and L_{i,out} for different rank levels i, such as:

$$L = {L}_{1 , out} + {\sum }_{i = 2}^{r} {L}_{i , i n} .$$

An important use case of the encoder ƒ_{θ} (x) trained as described above is so-called retrieval, i.e., the finding of further data samples x* from a specified set R that are as similar as possible to at least one specified query data sample x′.

For this purpose, data samples x from the set R are mapped onto representations z with the trained parameterized function ƒ_{θ} (x). Query data sample X′ is also mapped onto a representation z′ with the trained parameterized function ƒ_{θ} (x). In the space of the representations z, precisely those z* of the previously produced representations z are now sought that are situated closest to representation z′ of query data sample x′. The data sample x from the set R that was originally mapped onto this representation z* is ascertained as the sought data sample x* similar to query data sample x′. For one or more query data samples x′, this retrieval can supply one or more similar data samples x*. If the parameterized function ƒ_{θ} (x) has run through the training described above, the accuracy achieved during the retrieval is significantly better than if the parameterized function ƒ_{θ} (x) was trained only with conventional contrastive learning.

A further important use case of the encoder ƒ_{θ} (x) is the classification of data samples, such as images. Here, at least one query data sample x′ is mapped onto a representation z′ with the trained parameterized function ƒ_{θ} (x). This representation z′ is supplied to a classifier network K. Classifier network K then ascertains one or more classification scores for the assignment of the query data samples x′ to one or more classes of a specified classification. Here, for example the classifier network K can be trained simultaneously with the encoder ƒ_{θ} (x).

However, it is also for example possible to train only classifier network K, based on an already pre-trained encoder ƒ_{θ} (x) that is held fixed in its configuration. Further training of the pre-trained encoder ƒ_{θ} (x) to a limited extent is also possible.

Regardless of which variant is selected, the training described above of encoder ƒ_{θ} (x) results in a significant increase of the classification accuracy for test or validation data that were not used during the training.

This better classification accuracy can immediately be converted into better performance in technical applications that make use of the classification. Thus, in a further particularly advantageous embodiment, a control signal is formed from the classification score or scores. A vehicle and/or a system for quality control of products manufactured in series, and/or a system for monitoring regions, is controlled using this control signal. The operation of these systems relies particularly strongly on a reliable classification of the inputted data. The increase in this regard of the accuracy thus has the effect that, in a larger number of situations, the systems carry out a reaction that is appropriate to the respective situation acquired by measurement in the form of the measurement data.

The training described in accordance with the present invention above also makes it possible to distinguish, using the parameterized function ƒ_{θ} (x), whether an arbitrary data sample x′ belongs to the distribution defined by the set X of training samples x. This examination is important in order to assess whether a system that uses the encoder ƒ_{θ} (x) is still operating within the spectrum of input data for which this system (and here in particular the encoder ƒ_{θ} (x)) was trained. If, for example, an image classifier for traffic signs that uses the encoder ƒ_{θ} (x) is presented with a traffic sign that was newly introduced after the training, in this way it can be recognized that the training does not cover this newly introduced traffic sign.

For example, the traffic sign “environmental zone” is borrowed from the traffic sign “Tempo 30 zone,” in that the “30” is exchanged for the word “environment.” If the output of the image classifier were to be indiscriminately further processed, this could have the result that the traffic sign is incorrectly recognized as “Tempo 30 zone,” and for example a self-driving vehicle, on a city expressway having an 80 km/h speed limit, suddenly brakes to 30 km/h. If, in contrast, it is recognized that the traffic sign does not fit into the originally trained distribution of traffic signs, such surprises can be avoided.

Therefore, in an advantageous embodiment of the present invention, data samples x from a set R that belong to different classes of a specified classification are mapped onto representations z with the trained parameterized function ƒ_{θ} (x).

For each of these classes, a distribution of the representations z produced from data samples x of this class are ascertained. At least one query data sample x′ is mapped onto a representation z′ with the trained parameterized function ƒ_{θ} (x).

On the basis of the stated distributions, in each case probabilities are ascertained that the representation z′ belongs to this distribution. From these probabilities, it is in turn evaluated to what extent the query data sample x′ belongs to the distribution V defined by the set X of data samples x.

The method of the present invention can in particular be completely or partly computer-implemented. Therefore, the present invention also relates to a computer program having machine-readable instructions that, when they are executed on one or more computers, cause the computer or computers to carry out the described method. In this sense, control devices for vehicles and embedded systems for technical devices that are also capable of executing machine-readable instructions are also to be regarded as computers.

The present invention also relates to a machine-readable data carrier and/or to a download product having the computer program.

A download product is a digital product that can be transferred via a data network, i.e., is downloadable by a user of the data network, that may be offered for example in an online shop for immediate download.

In addition, a computer can be equipped with the computer program, with the machine-readable data carrier, or with the download product.

Further measures that improve the present invention are explained in the following, together with the description of the preferred exemplary embodiments of the present invention, on the basis of the figures.

### BRIEF DESCRIPTION OF THE DRAWINGS

FIGS. 1A-1D show an exemplary embodiment of method 100 for training an encoder ƒ_{θ} (x), in accordance with the present invention.

FIGS. 2A and 2B show an illustration of the problem for an example having images as data samples x.

FIG. 3 shows an accuracy recall curve in the retrieval of images using encoders ƒ_{θ} (x) that have been trained in different ways.

### DETAILED DESCRIPTION OF EXAMPLE EMBODIMENTS

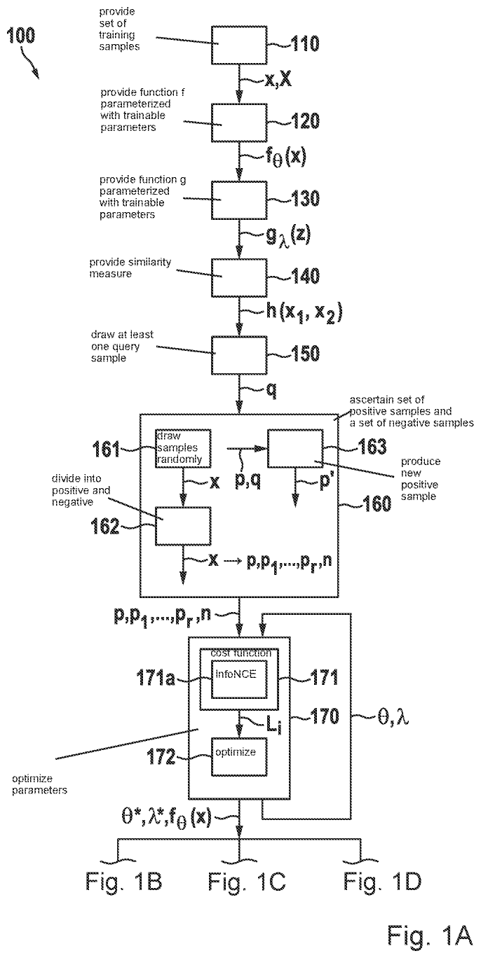

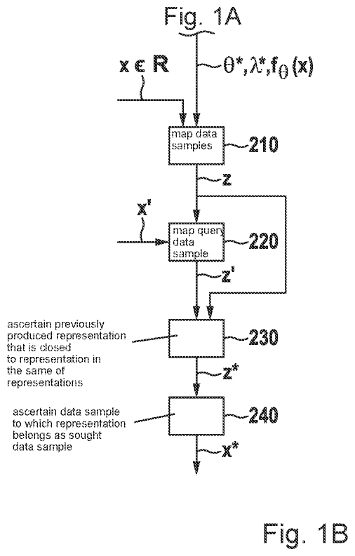

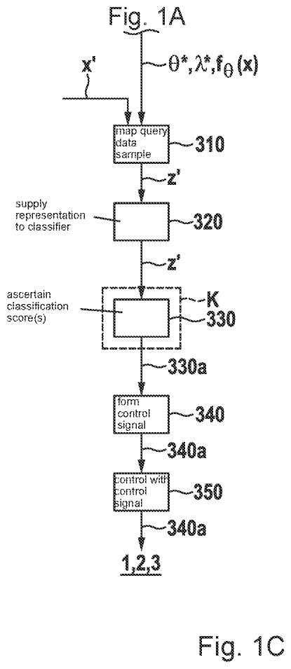

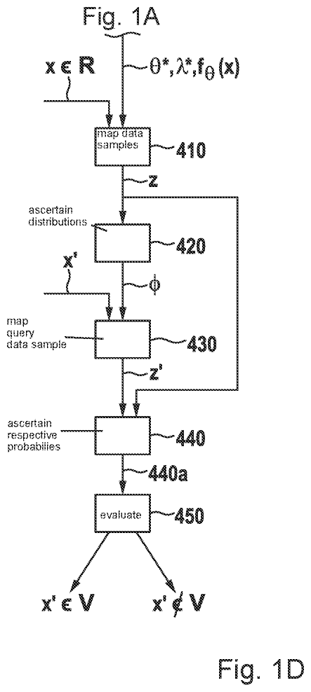

FIGS. 1A-1D show a schematic flow diagram of an exemplary embodiment of method 100 for training an encoder ƒ_{θ} (x).

FIG. 1A shows the method steps up to the obtaining of a trained encoder ƒ_{θ} (x).

In step 110, a set X of training samples x is provided; here, in the context of a specified application a relation is defined concerning the degree to which two samples x₁ and x₂ are similar to one another.

In step 120, a function ƒ_{θ} (x), parameterized with trainable parameters θ, is provided that maps samples x onto representations z.

In step 130, a function g_{λ} (z), parameterized with trainable parameters A, is provided that transfers representations z into a working space.

In step 140, a similarity measure h(x₁, x₂) is provided that assigns to samples x₁ and x₂ a similarity of the depictions g_{λ} (ƒ_{θ} (x₁)) and g_{λ} (ƒ_{θ} (x₂)) in the working space.

In step 150, at least one query sample q is drawn from the set X of training samples x.

In step 160, for this query sample q a set P, ordered in a ranked order, of positive samples p from the set X that are similar to the query sample q, and a set N of negative samples n from the set X that are no longer similar to the query sample q, are ascertained.

According to block 161, samples x can be drawn randomly from the set X. According to block 162, these samples x can then be divided into positive samples p, p₁, . . . , pᵣ and negative samples n.

According to block 163, a new positive sample p′ can be produced from the query sample q, and/or from an already-existing positive sample p, through the application of at least one processing step that does not change the semantic content of this sample.

In step 170, the parameters θ of the function ƒ_{θ} (x) and the parameters λ of the function g_{λ} (z) are optimized with the goal that the similarity measures h(q, p) are ordered corresponding to the ranked order of the positive samples p e P, and are greater than h(q, n) for all n ∈ N.

According to block 171, a cost function L can be set up that is a function of the parameters θ and λ via the similarity measures h(q, p) and h(q, n), L being a sum of contributions Lᵢ for the rank levels 1, . . . , r in the ranked order. Here, in particular for example according to block 171a, for each rank level i=1, . . . , r an InfoNCE cost function, in which:
the positive samples pᵢ ∈ Pᵢ of the respective rank level i are evaluated as positive samples,
the positive samples pᵢ ∈ Pᵢ for rank levels j<i remain not taken into account, and
the positive samples pᵢ ∈ Pᵢ for rank levels j. i are evaluated as negative samples,
   can be selected as contribution Lᵢ to cost function L. According to block 172, the parameters θ and κ can then be optimized with the goal of minimizing the cost function L assembled from the contributions Lᵢ.

The finally trained states of the parameters θ and λ are designated θ* and λ*. Of these, for further applications only the parameters θ*, which characterize the behavior of the function ƒ_{θ} (x), are required.

FIGS. 1B through 1D show exemplary applications of the trained encoder ƒ_{θ} (x).

FIG. 1B relates to the application of retrieval, in which a data sample x* is sought that is similar to a given data sample x.

In step 210, data samples x from a set R are mapped onto representations z with the trained parameterized function ƒ_{θ} (x).

In step 220, at least one query data sample x′ is mapped onto a representation z′, also with the trained parameterized function ƒ_{θ} (x).

In step 230, a previously produced representation z* is ascertained that is situated closest to this representation z′ in the space of the representations.

In step 240, the data sample x to which this representation z* belongs is ascertained as a sought data sample x* that is similar to the query data sample x′.

FIG. 1C relates to the application of the classification in which a query data sample x′ is to be assigned to one or more classes of a specified classification.

In step 310, at least one query data sample x′ is mapped onto a representation z′ with the trained parameterized function ƒ_{θ} (x).

In step 320, this representation z′ is supplied to a classifier network K.

In step 330, classifier network K ascertains one or more classification scores 330a for the assignment of the query data sample x′ to one or more classes of a specified classification.

In step 340, a control signal 340a is formed from the classification score or scores (330a).

In step 350, a vehicle 1, and/or a system 2 for the quality control of series-produced products, and/or a system 3 for monitoring regions, is controlled with this control signal 340a.

FIG. 1D relates to the recognition of whether or not a query data sample x′ belongs to a distribution V defined by the set X of training samples x (“in-distribution” or “out-of-distribution” (OOD)).

In step 410, data samples x from a set R that belong to different classes of a specified classification are mapped onto representations z with the trained parameterized function ƒ_{θ} (x).

In step 420, for each of these classes a distribution ϕ of the representations z produced from data samples x of this class is ascertained.

In step 430, at least one query data sample x′ is mapped onto a representation z′ with the trained parameterized function ƒ_{θ} (x).

In step 440, on the basis of the distributions ϕ, respective probabilities 440a that the representation z′ belongs to this distribution ϕ are ascertained.

In step 450, from these probabilities 440a it is evaluated to what extent the query data sample x′ belongs to or does not belong to the distribution V defined by the set X of training samples x ((x′ ∈ V) or (x′ ∉V)).

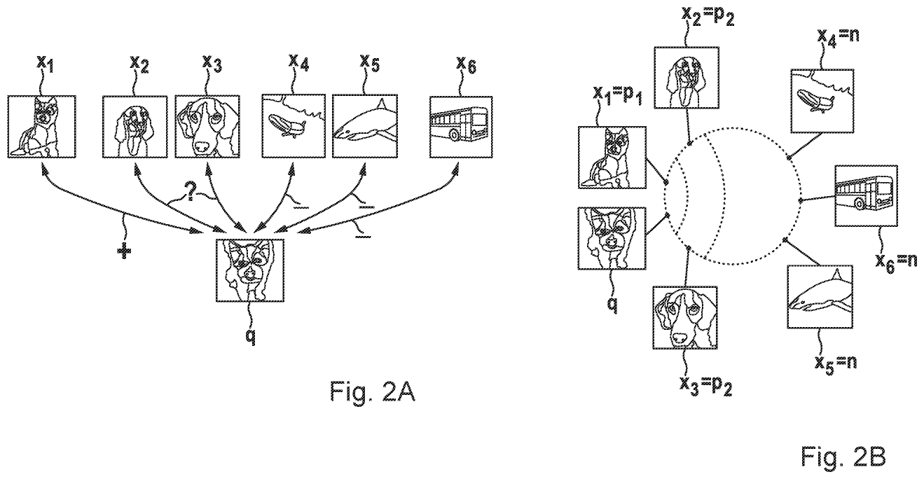

FIGS. 2A and 2B illustrate the problem solved using the present method 100 on the basis of images that show various objects.

In the situation shown in FIG. 2A, query sample q shows a dog of a particular breed. On the basis of this, it is immediately clear that sample x₁, which shows another dog of the same breed, is similar to query sample q and is thus to be evaluated as a positive example (+). It is also clear that
sample x₄, which shows a grasshopper,
sample x₅, which shows a shark, and
sample x₆, which shows a school bus have no similarity to a dog and are thus to be evaluated as negative examples (−).

With regard to samples x₂ and x₃, the situation is not as clear. These samples also show dogs, but these dogs are recognizably of a completely different breed than the dog in query sample q. Here, neither classification as a clear positive example nor classification as a clear negative example fits.

FIG. 2B shows how the problem is solved using method 100 presented above. Samples x₄, x₅, and x₆ are evaluated as negative samples n. For the positive samples p, a plurality of rank levels are introduced. The sample x₁ most similar to query sample q is evaluated as positive sample p₁ of the first rank. Samples x₂ and x₃, showing dogs of different breeds, are evaluated as positive samples p₂ of the second rank.

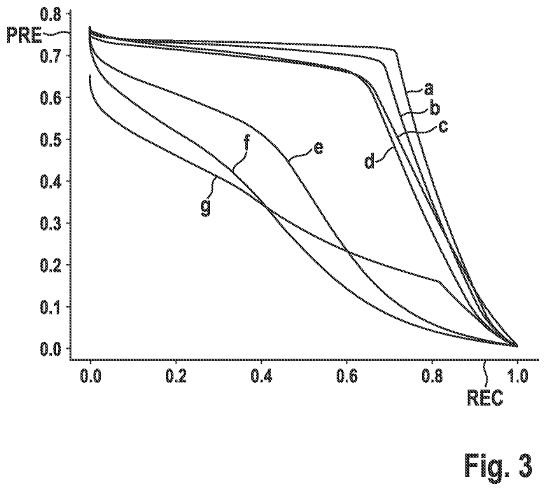

FIG. 3 shows as an example how the precision (PRE) in a retrieval task from the public CIFAR100 data set changes with the recall (REC). In the broadest sense, the recall is the ratio of:
the intersection set between the correctly selected samples and the totality of drawn samples, and
all possible samples.

Curves a through g were each obtained for identically carried-out experiments; only the manner in which function ƒ_{θ} (x) was trained was changed. The higher the curve runs, the better the “school” through which ƒ_{θ} (x) went turns out to be for the retrieval task.

Curve a was obtained after ƒ_{θ} (x) was trained with the method described above, the cost function L having been assembled from contributions L_{i,out}.

Curve b was obtained after ƒ_{θ} (x) was trained with the method 100 described above, the cost function L having been assembled as a mixture of contributions L_{i,out} and L_{i,in}. That is, for particular rank levels i contributions L_{i,out} were used, and for other rank levels i contributions L_{i,in} were used.

Curve c was obtained after ƒ_{θ} (x) was trained with a conventional cross-entropy cost function.

Curve d was obtained after ƒ_{θ} (x) was trained with method 100 described above, but cost function L was assembled from contributions L_{i,in}.

Curves e, ƒ, and g were obtained after ƒ_{θ} (x) was trained with monitored contrastive learning. For curve e, contributions of all positive samples p were summed; here, differing from the method presented here, no rank levels were introduced. For curve f, logarithms of the contributions were summed. For curve g, ƒ_{θ} (x) was trained with the 20 superclasses of the CIFAR 100 data set, instead of with the normal 100 classes.

What is claimed is:

1. A computer-implemented method for training an encoder that maps data samples of measurement data onto machine-evaluable representations, comprising the following steps:
providing a set of training samples x, a relation being defined, in the context of a specified application, concerning a degree to which two samples of the training samples are similar to one another;
providing a function ƒ_{θ} (x) that is parameterized with trainable parameters θ and that maps samples x onto representations z;
providing a similarity measure h(x₁, x₂) that assigns samples x₁ and x₂ a similarity of representations ƒ_{θ} (x₁) and ƒ_{θ} (x₂) and/or of processing products of the representations ƒ_{θ} (x₁) and ƒ_{θ} (x₂);
drawing from the set of training samples x, at least one query sample q;
for the query sample q, ascertaining:
a set P, ordered in a ranked order, of positive samples p from the set of training samples that are similar to the query sample q, the set P including subsets Pᵢ, . . . , Pᵣ of positive samples p₁, . . . , pᵣ for rank levels 1, . . . , r in the ranked order, and
a set N of negative samples n from the set of training samples that are no longer similar to the query sample q; and
optimizing at least the parameters θ with a goal that the similarity measures h(q, p) are assigned corresponding to the sequence of the positive samples p ∈ P and are greater than h(q, n) for all n ∈ N;
wherein a cost function L is set up that is a function of the parameters θ, via the similarity measures h(q, p) and h(q, n), and that is a sum of contributions Lᵢ for the rank levels 1, . . . , r in the ranked order; and
wherein the parameters θ are optimized with a goal of minimizing the cost function L.

2. The method as recited in claim 1, further comprising:
providing a function g_{λ} (z) parameterized with trainable parameters λ that transfers representations z into a working space;
forming depictions g_{λ} (ƒ_{θ} (x₁)) and g_{λ} (ƒ_{θ} (x₂)) in the working space as processing products of the representations ƒ_{θ} (x₁) and ƒ_{θ} (x₂);
evaluating the similarity of the depictions g_{λ} (ƒ_{θ} (x₁)) and g_{λ} (ƒ_{θ} (x₂)) with the similarity measure h(x₁, x₂); and
optimizing the parameters λ.

3. The method as recited in claim 1, wherein, for each rank level i=1, . . . , r, an InfoNCE cost function is selected as contribution Lᵢ to the cost function L, in which:
the positive samples pᵢ ∈ Pᵢ of the respective rank level i are evaluated as positive samples,
the positive samples pᵢ ∈ Pᵢ for rank levels j<i are left out of account, and
the positive samples pᵢ ∈ Pᵢ for rank levels j>i are evaluated as negative samples.

4. The method as recited in claim 3, wherein the InfoNCE cost function includes, for at least one rank level i=1, . . . , r:
a sum of contributions that originate from the positive samples pᵢ ∈ Pᵢ of the rank level i, or
a logarithm of such a sum of contributions.

5. The method as recited in claim 1, wherein the ascertaining of the positive samples p and the negative samples n for the at least one query sample q includes:
randomly drawing samples x from the set of training samples, and
dividing the randomly drawn samples x into the positive samples p, and the negative samples n.

6. The method as recited in claim 1, wherein the ascertaining of the positive samples p for the at least one query sample q includes producing a new positive sample p′ from the query sample q and/or from an already-present positive sample p through an application of at least one processing step that does not change a semantic content of the already-present positive sample, wherein the measurement data is images, and wherein the at least one processing step include:
selecting excerpts and subsequently enlarging back to an original image size, or
mirroring of images about an axis, or
adapting a brightness and/or contrast and/or a saturation based on parameters that are drawn from a random distribution, or
converting color into grayscale as a function of a specified probability.

7. The method according to claim 1, further comprising:
ascertaining a further data sample x* from a specified set R that is as similar as possible to at least one specified query data sample x′, by:
mapping data samples x from the set R onto representations z with the trained parameterized function ƒ_{θ} (x);
mapping the query data sample x′ onto a representation z′, also with the trained parameterized function ƒ_{θ} (x);
ascertaining a previously produced representation z* that is situated closest in the space of the representations to the representation z′; and
evaluating the data sample x that was originally mapped onto the representation z* as a sought data sample x* closest to the query data sample x′.

8. The method as recited in claim 1, further comprising:
mapping at least one query data sample x′ onto a representation z′ with the trained parameterized function ƒ_{θ} (x);
supplying the representation z′ to a classifier network; and
ascertaining, by the classifier network, one or more classification scores for an assignment of the query data sample x′ to one or more classes of a specified classification.

9. The method as recited in claim 8, further comprising:
forming a control signal from the one or more classification scores; and
controlling, with the control signal, a vehicle and/or a system for quality control of products produced in series and/or a system for monitoring regions.

10. The method as recited in claim 1, further comprising:
mapping data samples x from a set R that belong to different classes of a specified classification onto representations z with the trained parameterized function ƒ_{θ} (x);
ascertaining, for each class of the classes, a distribution ϕ of the representations z produced from data samples x of the class;
mapping at least one query data sample x′ onto a representation z′ with the trained parameterized function ƒ_{θ} (x);
based on the distributions ϕ, ascertaining for each distribution probabilities that the representation z′ belongs to the distribution ϕ; and
based on the probabilities, evaluating to what extent the query data sample x′ belongs to the distribution V defined by the set of training samples x.

11. The method as recited in claim 1, wherein the measurement data include images, and/or audio sequences, and/or video sequences.

12. A non-transitory machine-readable data carrier on which is stored a computer program for training an encoder that maps data samples of measurement data onto machine-evaluable representations, the computer program, when executed by a computer, causing the computer to perform the following steps:
providing a set of training samples x, a relation being defined, in the context of a specified application, concerning a degree to which two samples of the training samples are similar to one another;
providing a function ƒ_{θ} (x) that is parameterized with trainable parameters θ and that maps samples x onto representations z;
providing a similarity measure h(x₁, x₂) that assigns samples x₁ and x₂ a similarity of representations ƒ_{θ} (x₁) and ƒ_{θ} (x₂) and/or of processing products of the representations ƒ_{θ} (x₁) and ƒ_{θ} (x₂);
drawing from the set of training samples x, at least one query sample q;
for the query sample q, ascertaining:
a set P, ordered in a ranked order, of positive samples p from the set of training samples that are similar to the query sample q, the set P including subsets P₁, . . . , Pᵣ of positive samples p₁, . . . , pᵣ for rank levels 1, . . . , r in the ranked order, and
a set N of negative samples n from the set of training samples that are no longer similar to the query sample q; and
optimizing at least the parameters θ with a goal that the similarity measures h(q, p) are assigned corresponding to the sequence of the positive samples p ∈ P and are greater than h(q, n) for all n ∈ N;
wherein a cost function L is set up that is a function of the parameters θ, via the similarity measures h(q, p) and h(q, n), and that is a sum of contributions Lᵢ for the rank levels 1, . . . , r in the ranked order; and
wherein the parameters θ are optimized with a goal of minimizing the cost function L.

13. One or more computers configured to for training an encoder that maps data samples of measurement data onto machine-evaluable representations, the one or more computers configured to:
provide a set of training samples x, a relation being defined, in the context of a specified application, concerning a degree to which two samples of the training samples are similar to one another;
provide a function ƒ_{θ} (x) that is parameterized with trainable parameters θ and that maps samples x onto representations z;
provide a similarity measure h(x₁, x₂) that assigns samples x₁ and x₂ a similarity of representations ƒ_{θ} (x₁) and ƒ_{θ} (x₂) and/or of processing products of the representations ƒ_{θ} (x₁) and ƒ_{θ} (x₂);
draw from the set of training samples x, at least one query sample q;
for the query sample q, ascertain:
a set P, ordered in a ranked order, of positive samples p from the set of training samples that are similar to the query sample q, the set P including subsets P₁, . . . , Pᵣ of positive samples p₁, . . . , pᵣ for rank levels 1, . . . , r in the ranked order, and
a set N of negative samples n from the set of training samples that are no longer similar to the query sample q; and
optimize at least the parameters θ with a goal that the similarity measures h(q, p) are assigned corresponding to the sequence of the positive samples p e P and are greater than h(q, n) for all n ∈ N;
wherein a cost function L is set up that is a function of the parameters θ, via the similarity measures h(q, p) and h(q, n), and that is a sum of contributions Lᵢ for the rank levels 1, . . . , r in the ranked order; and
wherein the parameters θ are optimized with a goal of minimizing the cost function L.
